(19) United States
(12) Patent Application Publication
(10) Pub. No.: US 2024/0303075 A1
(43) Pub. Date: Sep. 12, 2024

(54) CLUSTERING CHURN ANALYTICS TO EFFICIENTLY IDENTIFY HIGH-LEVEL CODE FLAWS

(71) Applicant: HEWLETT PACKARD ENTERPRISE DEVELOPMENT LP, Spring, TX (US)

(72) Inventors: Soumitra CHATTERJEE, Bangalore (IN); Ritanya BHARADWAJ, Bangalore (IN); Veena KONNANATH, Bangalore (IN); Sunil KURAVINAKOP, Bangalore (IN); Balaji Sankar Naga Sai Sandeep KOSURI, Bangalore (IN)

(21) Appl. No.: 18/181,427

(22) Filed: Mar. 9, 2023

(51) Int. Cl. G06F 8/75; G06F 8/77

(52) U.S. Cl. CPC G06F 8/75; G06F 8/77

(57) ABSTRACT

Systems and methods are provided for identifying and reporting possible fragile lines of code from a repository of codes. In particular, some examples cluster the lines of codes containing similar values of bug/defect-related churn data instances and report the lines of code containing bug/defect-related churn data instances with high numbers of bug/defect-related churn data.

### BACKGROUND

Software project management is a complex task. A single project may comprise a large repository of source code that is constantly being modified by a large group of developers. The purpose for these modifications may stem from new design implementations, improvements in design, or overcoming bugs/defects. The volume and complexity of source code along with constant modifications have made it difficult to track and detect bugs/defects. Software bugs/defects have often contributed to escalating cost and draining engineering resources. Studies have acknowledged the high costs associated with overcoming software bugs/defects throughout the life cycle of the source code.

### BRIEF DESCRIPTION OF THE DRAWINGS

The present disclosure, in accordance with one or more various examples, is described in detail with reference to the following figures. The figures are provided for purposes of illustration only and merely depict typical or example examples.

FIG. 1 illustrates, at a high level of generality, an environment with an integrated fragile code identifier in accordance with examples of the technology disclosed herein.

FIG. 2 illustrates an example method in accordance with examples of the technology disclosed herein.

FIG. 3 illustrates an example matrix reporting the number of bug/defect-related churn data instances by file name within a repository of source code in accordance with examples of the technology.

FIG. 4 illustrates an example matrix including line-by-line reporting of the number of bug/defect-related churn data instances in accordance with examples of the technology disclosed herein.

FIG. 5 illustrates an example bar graph of the number of bug/defect-related churn data instances for each source code line and clusters deduced based on statistical analysis in accordance with examples of the technology disclosed herein.

FIG. 6 illustrates an example computing device in accordance with examples of the technology disclosed herein.

FIG. 7 illustrates a block diagram of an example computer system in accordance with examples of the technology disclosed herein.

The figures are not exhaustive and do not limit the present disclosure to the precise form disclosed.

### DETAILED DESCRIPTION

As alluded to above, high costs are often associated with overcoming software bugs/defects throughout the life cycle of the source code. Thus, there is a need and desire to address code fragility, which can refer to the tendency for source code to “break,” i.e., cause errors or faults when the source code is changed. There are several reasons for the high costs of attending to bugs/defects. First, detection and correction of bugs/defects are typically reactive efforts as opposed to taking proactive measures. A reactive system usually prompts corrective action upon detecting an error. Unfortunately, correction of a single error may spawn additional errors that spawn still other errors, prompting subsequent operations to detect errors in the source code, that also need correcting. This process continues until the source code is mostly eradicated of errors. On the other hand, a proactive system for detecting fragile areas of/in source code would allow for fewer detection operations or phases. This is because fragile areas of source code may be proactively corrected, in order to reduce its fragility, and consequently reducing the likelihood of bugs/defects spawning from future changes or corrections that would have otherwise spawned additional errors to the source code.

One way to identify fragile code is through code churn (also known as rework). Code churn can refer to a measure or indication of how often a file (in this context, a source code file/file containing source code) changes or is edited. Software developers often correlate high churn data with fragile code and past studies have confirmed this correlation. It should be understood that the analysis alluded to above, regarding fragile code identification, may be conducted at the source code level, and can be premised on the associated number of code churns. The analysis can be performed from the developer's perspective, again, looking at actual code churn, rather than end user/customer-identified problems, to periodically assess the durability of the source code. Reliance on code churn, as opposed to the use of defect and test cases (relied on by other methods) to detect fragile code, requires limited and simplified setup. That is, implementation of examples of the disclosed technology are not reliant on developing robust test cases to capture all experienced defect types as well as do not require complex runtime environments to reproduce end-user/customer error conditions. Moreover, examples of the disclosed technology involve limited parsing. Further still, other methods are generally reactive (rather than proactive) to defect discovery.

However, relying on churn data blindly/without further consideration may result in oversensitivity. That is, relying on churn data alone as an indicator of code fragility may result in erroneous or inaccurate identification of areas of the source code with bugs/defects. This is because software changes and the creation or existence of churn data may occur for different reasons. In some instances, code churn may be the result of bug/defect correction, but in other instances, may be the result of new features/functionality additions in the source code. Therefore, an effective bug/defect detection system should be employed to distinguish between these two types of code churn, and analyze bug/defect-correcting churn data.

The complexity of source code also adds to its cost. Some tools review a repository of source code for the highest number of reported bugs/defects. However, each source code file may contain thousands of lines of code. In order to review a source code, developers may conduct a line-by-line review of the source code/a source code file to find defects/bugs.

Moreover, line-by-line review of the source code can be overly granular, i.e., focusing on individual lines of source code without considering related/neighboring lines of source code may miss bugs/defects that result from the interaction between multiple lines of source code. For example, reviewing lines of code separately/standing alone in a vacuum, may result in bugs/defects being missed.

Finally, methods and systems should enable early detection of fragile code. Studies have suggested a “shift-left approach” to software testing because of an expected dramatic increase in cost to repair defects with progression in the software's development. The “shift-left approach” allows for earlier defect detection, but under this approach, such defects are addressed in isolation without assessing the causal relationship of the defect. As alluded to above, this approach may further propagate later defects resulting from these isolated fixes. The utilization of code churn to identify fragile code may identify/consider at least some of the causal relationships, while being available throughout the life of the source code from coding through release.

Accordingly, examples of the disclosed technology are directed to solutions rooted in computer technology to overcome the above-described issues with conventional source code bug/defect detection and resolution, In particular, examples of the disclosed technology provide systems and methods for preemptive identification of bugs/defects based on identifying instances of bug/defect-related churn data. The systems and methods disclosed herein may report possible fragile areas of source code within a repository of source code. Thus, the examples of the disclosed technology will be referred to as a fragile code identifier. In some examples, the systems and methods may retrieve churn data associated with source code, and identify instances of bug/defect-related churn data. Using the identified bug/defect-related churn data instances, a data structure may be generated with entries representing at least individual lines of the source code and its recorded number of bug/defect-related churn data instances. Based on statistical analysis of the associated number of bug/defect-related churn data instances, the entry representing a single line of the source code may be clustered with its neighboring/consecutive entries, representing neighboring/consecutive lines of the source code, creating a single clustered entry that represents an area of the source code. The clustered entries may be reported to the user as possible fragile areas of the source code.

In some examples, the disclosed technology may review logs of commits and identify records of bug/defect-related commits rather than identifying instances of bug/defect-related churn data. While churn data records represent rework of source code, commits are operations that send the source code's latest changes to the repository. In this example of the disclosed technology, the previously disclosed instances of bug/defect-related churn data is replaced with records of bug/defect-related commits and this information is obtained from logs of commits associated with the source code.

In some examples, the disclosed technology may communicate with various systems. Churn data in the form of code churn metrics is retrieved from a source revision control system such as a source code management system (SCM). The retrieved code churn metric may be supplemented with additional code churn information from a bug tracking system (BTS) in order to identify bug/defect-related churn data instances. In some examples, the BTS is replaced by an issue tracking system. In other examples, the disclosed technology may communicate with an interface module that communicates with the SCM and the BTS.

The clustering process may rely on statistical analysis(es) to identify potential fragile areas of code. The statistical analysis may include computing a standard deviation value based on the number of bug/defect-related churn data instances of each source code line. In some examples, the statistical analysis may utilize other forms or types of calculations such as interquartile range, mean absolute difference, median absolute deviation, average absolute deviation, etc. In other examples, the statistical analysis may include computing a standard deviation value and may also utilize other forms of statistical analysis.

The systems and methods disclosed herein may be implemented with any of a number of computing systems. For example, the systems and methods disclosed herein may be used within hardware, hardwire system, a wirelessly connected system, or through the internet. In addition, the principles disclosed herein may also extend to other network types. An example system in which examples of the disclosed technology may be implemented is illustrated and described below as one example, but the system nature is not necessary for the operation of the disclosed technology, nor is it limiting on the disclosed technology.

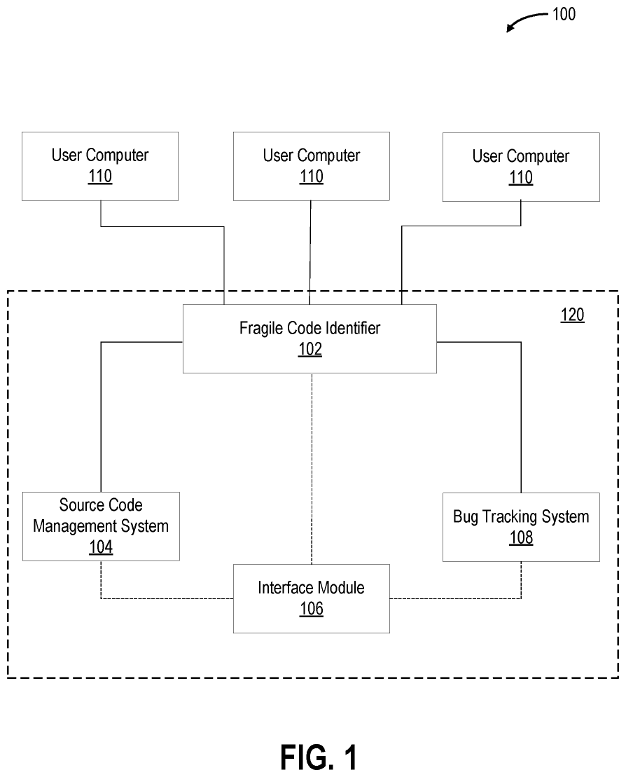

FIG. 1 illustrates, at a high level of generality, an environment 100 with an integrated fragile code identifier 102 in accordance with examples of the technology disclosed herein. the examples include fragile code identifier 102 that communicates with bug tracking system (BTS) 108 and a source code management system (SCM) 104, further details of which are provided below. It may become apparent to those skilled in the art that any form of source revision control system or equivalent may be used in lieu of SCM 104. Similarly, any issue tracking system or equivalent may be used in lieu of BTS 108. Fragile code identifier 102, BTS 108 and SCM 104 may provide their respective services to user computers 110 typically over a network or through a wired connection(s) (a hashed area 120 represents this flexibility). Although illustrated as if housed at a single location, those skilled in the art will realize that fragile code identifier 102, BTS 108 and SCM 104 can be implemented at a locally-hosted computing facility or using distributed, cloud-based data center infrastructure. Depending on the implementation environment, the network can be a local area network or the Internet.

When active, fragile code identifier 102 may communicate to user computers 110, BTS 108, SCM 104, or may utilize an interface module 106 to communicate to BTS 108 and SCM 104. Fragile code identifier 102 can be an application located on individual user computer 110 that performs the methods described herein in accordance with the principles of the present disclosure. Fragile code identifier 102 normally remains dormant until a user through user computer 110 prompts its activation. In some examples, a user can schedule periodic activation to prompt fragile code identifier 102 to automatically conduct its analysis described in more detail below. The periodic activation may be user directed or may be preprogrammed. Activation may be daily, weekly, monthly, annually, or any other periods. Activation may also be based on events, such as upon a change to a repository of source code.

SCM 104 may maintain repositories of source code and other data pertaining to individual software development projects. In the course of project development using an SCM 104, users of user computers 110 may take certain actions with respect to a repository that result in events occurring in SCM 104. Information about these SCM-repository events may be stored in the repository along with the other information that may be relevant to document revisions made to the source code files as well as the general course of development of the project.

BTS 108 and SCM 104 may be in communication with each other by way of the interface module 106. Interface module 106 is illustrated in FIG. 1 as a unit that is separate to BTS 108 and SCM 104. However, those skilled in the art will realize that the module could be integrated either at the software or hardware level into BTS 108. Communication between SCM 104 and BTS 108 may occur over network or other suitable channels depending on the respective network locations of the two systems.

SCM 104 may include code churn information in the form of code churn metrics. The code churn metrics generally measure the interaction between programmers and the source code. The code churn metrics may include, but is not limited to the number of revisions to a file/method/class/routine, the number of times a file has been refactored, which involves restructuring a code without changing or adding to its external behavior and functionality, the number of different authors that have touched a file/method/class/routine, and the number of times a particular file/method/class/routine has been involved in a bug-fixing. Additional code churn metrics may include the sum of all revisions of the lines of code added to file, the sum of all lines of code minus the deleted lines of code over all revisions, the maximum number of files committed together, and the age of file in weeks counted backwards from the release time. In some examples, SCM 104 may provide logs of commits established by programmers onto the source code. Information within logs of commits may include commit hashes, which are unique identifiers associated with individual commits, commit authors, commit dates, and commit messages written by the commit authors.

BTS 108 is a system that may contain code churn information that is different from the code churn information from SCM 104. This code churn information pertains more specifically to reported bugs or defects, whereas the code churn metrics or logs of commits represent records of interaction between programmers and the source code. The BTS 108 may be created using a variety of different architectures. As an example, a client server architecture is described below in which the BTS 108 functionality is provided by a server computer and accessed by users from user computers 110. For each bug that has been identified, BTS 108 may maintain a bug identifier token, a bug description, a title, the name of the person that found the bug, and an identifier of the component with the bug. BTS 108 may also maintain additional information regarding a bug such as the specific version release with the bug, the specific hardware platform with the bug, the date the bug was identified, a log of changes made to address the bug, the name of the developer and/or manager assigned to the bug, whether the bug is interesting to a customer, the priority of the bug, the severity of the bug, and/or other custom fields. The same information may be included when correcting a defect. When a particular bug tracked by BTS 108 is addressed by a programmer, the programmer may correlate the particular bug to a bug identifier token. SCM 104 may then update all the associated information such as the log of changes made to address the bug and the specific code segments modified. Thus, the number of times a code section has been modified due to bug-fixing can be tracked. If a bug is associated with a new feature being added, the system may also provide a link to the feature in a feature tracking system.

Fragile code identifier 102 may retrieve relevant information through BTS 108, SCM 104 or interface module 106. Using this information, fragile code identifier 102 may process the retrieved code churn metrics and code churn information. Fragile code identifier 102 may refer to the relevant information from BTS 108 in order to filter out the code churn metrics that are not instances of churn data that are of bug/defect-related churn data. In some examples, BTS 108 may include line-by-line instances of churn data that are of bug/defect-related churn data. In this scenario, fragile code identifier 102 may retrieve the code churn information from BTS 108 and may not need to retrieve the code churn metrics from SCM 104 or interface module 106. In some examples, SCM 104 may already include the line-by-line level of instances of churn data that are of bug/defect-related churn data and therefore fragile code identifier 102 may not need to retrieve code churn information from BTS 108.

Fragile code identifier 102 may report to the user through user computer 110 of potentially problematic areas of code. The reporting may be in a form of a report, a chart, or other forms of notification specifying areas of code that are potentially fragile. In one example, the output may be in a form of a data structure.

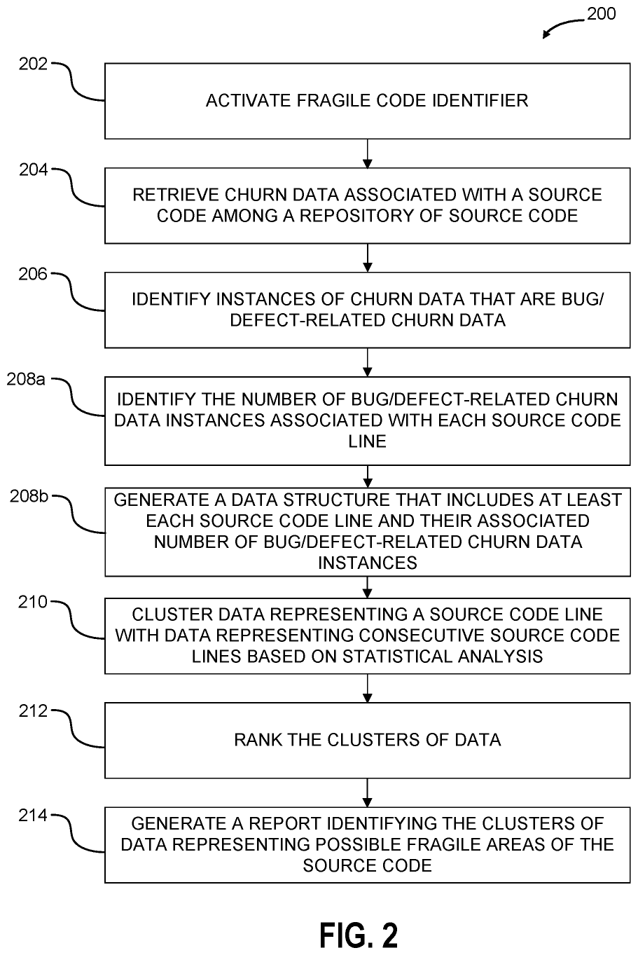

FIG. 2 illustrates an example method in accordance with examples of the technology disclosed herein. The following disclosure is made in reference to both FIG. 1 and FIG. 2 in order to facilitate an easier understanding of the interactions that effectuate the described operations. The example method 200 is provided for illustrative purposes only and should not be interpreted as limiting the scope of the claims to only the depicted example. At operation 202, fragile code identifier 102 is activated. As discussed previously, activation may occur when the user through the user computer 110 activates fragile code identifier 102 as a direct command, or through a scheduled periodic activation. In some examples, fragile code identifier 102 may activate after recognizing an event.

At operation 204, fragile code identifier 102 may retrieve code churn information of a source code from a repository of source code. The code churn information may include code churn metrics or logs of commits. The code churn metrics may include the number of revisions to a file/method/class/routine, the number of times a file has been refactored, the number of different authors that have touched a file/method/class/routine, and the number of times a particular file/method/class/routine has been involved in a bug-fixing. Logs of commits may include commit hashes, which are unique identifiers associated with individual commits, commit authors, commit dates, and commit messages written by the commit authors. In some examples, fragile code identifier 102 may retrieve code churn information from BTS 108, which at least includes the bug identifier token along with other information pertaining to specific bug fixing commits. The code churn information retrieved from BTS 108 may also include a bug description, a title, the name of the person that found the bug, and an identifier of the component with the bug. The code churn information from BTS 108 may also include the specific version release with the bug, the specific hardware platform with the bug, the date the bug was identified, a log of changes made to address the bug, the name of the developer and/or manager assigned to the bug, whether the bug is interesting to a customer, the priority of the bug, the severity of the bug, and/or other custom fields. Fragile code identifier 102 may retrieve the code churn information directly from SCM 104 and BTS 108 or delegate this operation to interface module 106. Operation 204 may be conducted for each source code within a repository of source code. In some examples, operation 204 may be conducted for multiple repositories of source code.

At operation 206, fragile code identifier 102 may identify instances of churn data that are bug/defect-related. In some examples, fragile code identifier 102 may identify records of commits that are bug/defect-related. Fragile code identifier 102 may identify bug/defect-related churn data instances by correlating the code churn metrics from SCM 104 with the code churn information from BTS 108. More specifically, fragile code identifier may compare entries representing instances in the code churn metrics with a bug tracking record from the code churn information and identify entries in the code churn metrics that are associated with an entry in the bug tracking record. Operation 206 may also include counting the identified bug/defect-related churn data instances. In some examples, this operation may include at least comparing the bug identifier token with an entry within the code churn metrics. In some examples, operation may exclude entries within the code churn metrics that are associated with feature addition commits, instead of identifying bug/defect-related churn data instances.

Operation 206 may be completed for each source code within a repository of source code. Fragile code identifier 102 may generate a data structure that at least includes a number of bug/defect-related churn data instances for each source code. In some examples, the data structure at least includes a number of bug/defect-related commit records for each source code. The data structure may be a matrix or an array. In some examples, the matrix may be created only as a processing tool to assist fragile code identifier 102 as a processing tool and may not be in a human-readable format. In some examples, the matrix may be in a human-readable format and may be reported to the user.

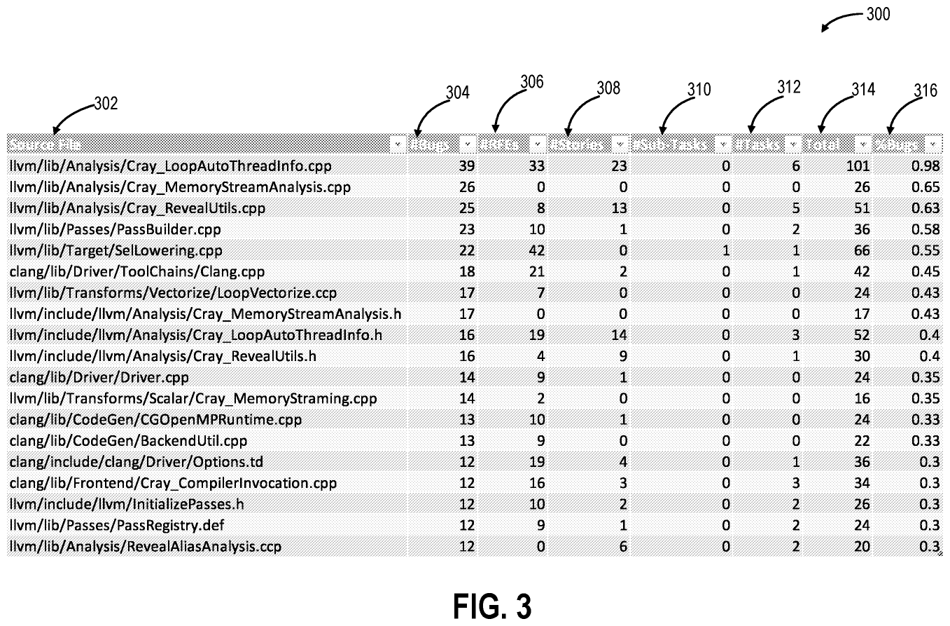

FIG. 3 illustrates an example matrix 300 reporting the number of bug/defect-related churn data instances by file name within a repository of source code in accordance with examples of the technology disclosed herein. The example matrix 300 is provided for illustrative purposes only and should not be interpreted as limiting the scope of the claims to only the depicted example. In this example, bug/defect-related churn data instances were identified for a repository of source code for Cray Compiling Environment. Matrix 300 may include various categories of information (columns) for individual source code (rows). In some examples, the categories of information may be user defined. In other examples, the categories of information may be modified by the user. In few examples, the selection of categories is performed by artificial intelligence (AI).

Here, the list of source files 302 may be identified in the first column. As mentioned previously, the list of source files 302 may be extracted from SCM 104 during initial review of the repository of source code. The remaining categories of information may include number of bugs 304, number of request for enhancements (RFE) 306, number of stories 308, number of sub-tasks 310, number of tasks 312, total number of events 314, and percent of churn data that were bug/defect fixes 316.

Along with the listed columns of information, the matrix 300 may include additional information. Additional information may include the total number of churn data reported by SCM 104 in order to calculate the percent of bug changes. In the example matrix, the percent of churn data that were bug fixes 316 for LoopAutoThreadInfo.cpp was found to be 0.98 percent because the fragile code identifier 102 calculated 4,000 bugs (not shown) to exist within a repository of files within the SCM 104 and the fraction of 39 bug/defect-related churn data instances divided by 4,000 bugs results in 0.98 percent of churn data being bug/defect-related churn data instances for the LoopAutoThreadInfo.cpp source code. The list of source code may be ordered by the number of bug/defect-related churn data instances. The example matrix may be ordered by the percent of churn data that were bug fixes 316. However, many examples may sort the matrix by the number of bugs 304.

Returning to FIG. 2, at operation 208a, fragile code identifier 102 may identify the number of bug/defect-related churn data instances associated with each source code line. The fragile code identifier 102 may review the filtered code churn metrics from operation 206 for each source code, and correlate the filtered code churn metrics with the associated code churn information from BTS 108 in order to identify the bug/defect-related churn data instances for each line of code. In some examples, fragile code identifier 102 may identify the number of bug/defect-related commit records associated with each source code line.

Fragile code identifier 102 may create a data structure including individual lines of code and the number of bug/defect-related churn data instances at operation 208b. The data structure is usually in a form of a matrix, but may also be in an array, that may at least includes individual lines of code (rows) and the number of bug/defect-related churn data instances (column). Fragile code identifier 102 may be pre-programmed to create a data structure with additional categories of information (columns). In other examples, the individual lines of code are columns and the number of bug/defect-related churn data instances are rows. In some examples, the user may program the categories of information on the data structure. In some examples, the matrix may be created only as a processing tool to assist fragile code identifier 102 as a processing tool and may not be in a human-readable format. In some examples, the matrix may be in a human-readable format and may be reported to the user.

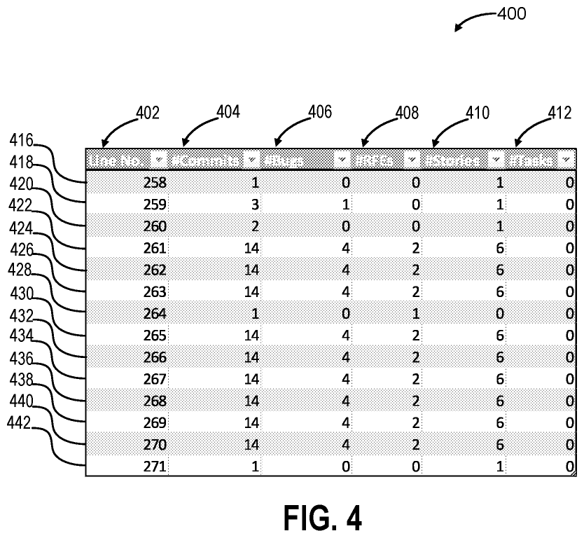

FIG. 4 illustrates an example matrix 400 including line-by-line reporting of the number of bug/defect-related churn data instances in accordance with examples of the technology disclosed herein. The example matrix 400 is provided for illustrative purposes only and should not be interpreted as limiting the scope of the claims to only the depicted example. In this example, matrix 400 is in a form of human-readable format. Matrix 400 may include entries that are organized by individual line of code 402. For every source code line, each entry may represent a number of commits 404, number of bugs 406, number of RFEs 408, number of stories 410, and number of tasks 412. For example, line number 263 (426) may have 14 commits, 4 bugs, 2 RFEs, 6 stories and 0 tasks. In some examples, additional categories of information may be included within the matrix.

Returning to FIG. 2, at operation 210, the fragile code identifier 102 may cluster data representing a source code line with consecutive source code lines based on some statistical analysis(es). In one example, the fragile code identifier 102 may calculate a standard deviation value of bug/defect-related churn data instances associated with each line of the source code as a rule to cluster the consecutive source code lines. In this example, for each source code line, the fragile code identifier 102 calculates the difference between the number of bug/defect-related churn data instances associated with the source code line and the consecutive source code line. The fragile code identifier then compares the calculated difference and the standard deviation value. If the absolute value of the calculated difference is less than or equal to the standard deviation value, the consecutive source code line is added to a cluster that includes the source code line. Otherwise, if the absolute value of the calculated difference is greater than the standard deviation value, the cluster that includes the source code line is complete and a new cluster is formed for the consecutive source code line. This calculation and comparison is completed for each source code line. Indeed, in this example, the fragile code identifier 102 immediately creates a cluster that includes at least the first source code line. In some examples, fragile code identifier 102 may cluster data associated with these lines of code to create a single “line” data (e.g., referring back to FIG. 4, source code line number 261 422 for matrix 400) that includes multiple lines of code. In some examples, the threshold value may be preprogrammed within fragile code identifier 102. In some examples, the threshold value may be selected by the user. In some examples, an algorithm other than standard deviation may be used as criteria to cluster the lines of code.

The example that uses standard deviation is now detailed below. Referring back to FIG. 4, assume that the standard deviation value for the number of bug/defect-related churn data instances based on every line of a source code is 1.89. FIG. 4 depicts the number of bug/defect-related churn data instances associated with line numbers 258 (416) through 271 (442). Assume further that line 258 (416) is a start of a new cluster. Fragile code identifier 102 will calculate the difference between the number of bug/defect-related churn data instances of lines 259 (418) and 258 (416). The absolute value of the calculated difference is 1, which is less than the standard deviation value of 1.89, and therefore fragile code identifier 102 creates a cluster that includes lines 258 (416) and 259 (418). The same calculation and comparison are performed between lines 260 (420) and 259 (418). Here, the absolute value of the difference between the number of bug/defect-related churn data instances for lines 260 (420) and 259 (418) is 1. Since the absolute value of the difference is less than the standard deviation value, line 260 (420) is added to the cluster containing lines 258 (416) and 259 (418). Next, the same calculation and comparison are performed for lines 261 (422) and 260 (420). Here, absolute value of the difference is 4, which is greater than the standard deviation value of 1.89. Therefore, a new cluster is formed that includes line 261 (422). The same calculation and comparison are completed for the remaining lines. In this example, FIG. 4 depicts a scenario in which five clusters are formed between lines 258 (416) and 271 (442). The first cluster includes lines 258 (416) through 260 (420). The second cluster includes lines 261 (422) through 263 (426). The third cluster includes line 264 (428). The fourth cluster includes lines 265 (430) through 270 (440). Finally, the fifth cluster includes line 271 (442).

Operations 208a, 208b and 210 described above may be repeated for every source code within a repository of source code before initiating operation 212. In some examples, operations 208a, 208b and 210 described above may be repeated for multiple repositories of source code.

At operation 212, fragile code identifier 102 may rank the clusters of data. Usually, fragile code identifier 102 prioritizes clusters of data representing source code lines with greater average number of bug/defect-related churn data instances. In one example, the ranking is based on the average number of records of bug/defect-related commits per line. Fragile code identifier 102 may also prioritize larger clusters, i.e. the larger number of source code lines forming a cluster. For example, referring back to the FIG. 4 example, the clusters for lines 261 (422) through 263 (426) and lines 265 (430) through 270 (440) both include an average number of bug/defect-related churn data instances of 4 instances per line. The cluster of lines 261 (422) through 263 (426) comprises three lines, while the cluster of lines 265 (430) through 270 (440) comprises six lines. In this example, the fragile code identifier 102 will prioritize the cluster for lines 265 (430) through 270 (440) because this cluster includes a greater number of source code lines. In other examples, the size of the cluster may be a variable in a formula associated with ranking the clusters. Here, the formula, rather than the average number of bug/defect-related churn data instances, may be used to rank the clusters. The formula may allocate points to each number of bug/defect-related churn data instances, but may also associate points to the number of source code lines forming a cluster. Thus, a larger cluster containing many lines of code with smaller average number of bug/defect-related churn data instances per line may be ranked higher than a smaller cluster of lines of code with greater average number of bug/defect-related churn data instances. In some examples, the fragile code identifier 102 may compare the average number of bug/defect-related churn data instances to a threshold value. Here, clusters with average numbers of bug/defect-related churn data instances not exceeding the threshold value may be ignored and are not ranked. The threshold value may be pre-coded onto fragile code identifier 102. In some examples, the threshold value may be user-defined In few examples, the threshold value may be based on AI, where feedback may be provided by the user as to the accuracy of the reported information.

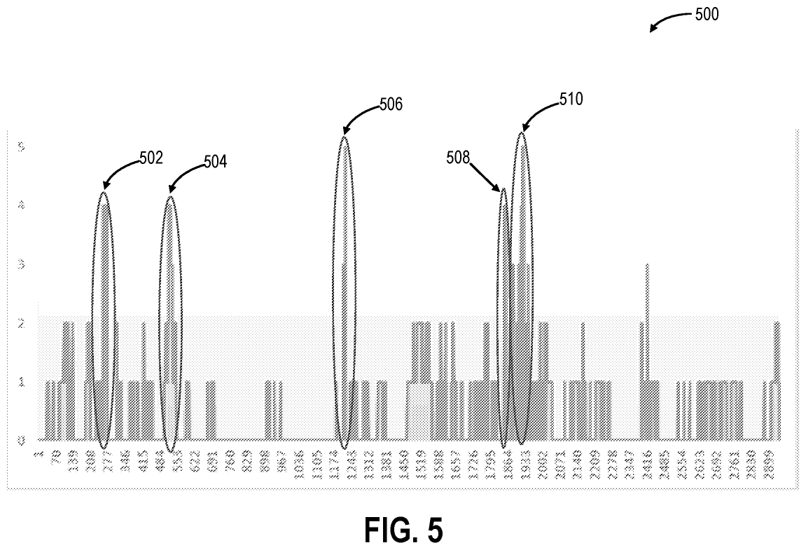

FIG. 5 illustrates an example bar graph 500 of the number of bug/defect-related churn data instances for each cluster in accordance with examples of the technology disclosed herein. The example bar graph 500 is provided for illustrative purposes only and should not be interpreted as limiting the scope of the claims to only the depicted example. The bar graph 500 may be organized as the number of bug/defect-related churn data instances (y-axis) versus the line on which the bug/defect-related churn data instances is located (x-axis). The created bar graph may be provided to the user in a human-readable format. In some examples, the bar graph is not generated and fragile code identifier 102 may only provide a list of potentially fragile lines of code. If the bar graph is provided, clusters may be marked or otherwise identified. Clusters 502, 504, 506, 508, and 510 may be highlighted (as shown) and provided to the user. In this example, fragile code identifier 102 may only seek clusters with the two largest numbers of bug/defect-related churn data instances per line, which may be five and four bug/defect-related churn data instances per line. Fragile code identifier 102 may provide the lines associated with each cluster and may also provide the number of bug/defect-related churn data instances. In some examples, the threshold number of bug/defect-related churn data instances may be user assigned. In this scenario, the user may specify a value of bug/defect-related churn data instances per line, such as four, and the fragile code identifier 102 will provide all clusters that were measured of having four or more bug/defect-related churn data instances per line.

At operation 214, fragile code identifier 102 may generate a report identifying clusters that are representing possible fragile areas of a source code. The numbers of bug/defect-related churn data instances may also be reported to the user. In one example, the number of bug/defect-related commit records may also be reported to the user. As previously stated, the selection of clusters for reporting may be based on the clusters with the most recorded bug/defect-related churn data instances or clusters that exceeded the threshold value of bug/defect-related churn data instances. The provided report may be in a form of a data structure from operation 208b with clustered entries that at least include the associated number of bug/defect-related churn data instances or a bar graph as shown on FIG. 5.

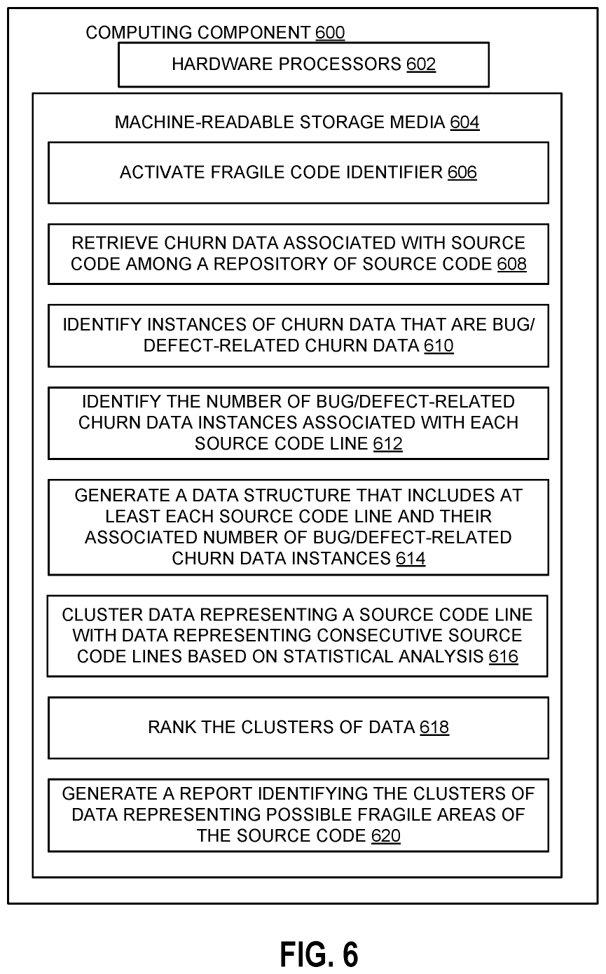

FIG. 6 illustrates an example computing device in accordance with examples of the technology disclosed herein. Computing device 600 includes hardware processors 602. In various examples, hardware processors 602 may include one or more processors.

Hardware processor 602 may be one or more central processing units (CPUs), semiconductor-based microprocessors, and/or other hardware devices suitable for retrieval and execution of instructions stored in machine-readable storage medium 604. Hardware processor 602 may fetch, decode, and execute instructions, such as instructions 606-620, to control processes or operations for identifying fragile sections of a source code among a repository of source code. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Non-limiting examples include flash memory, solid state storage devices (SSDs); a storage area network (SAN); removable memory (e.g., memory stick, CD, SD cards, etc.); or internal computer RAM or ROM; among other types of computer storage mediums. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 604 may be a non-transitory storage medium, where the term “non-transitory”does not encompass transitory propagating signals. As described in detail below, machine-readable storage medium 604 may be encoded with executable instructions, for example, instructions 606-620.

Hardware processor 602 may execute instruction 606 to activate fragile code identifier 102. In certain examples, hardware processor 602 may execute this operation in response to user input. In other examples, the execution of this operation may be initiated in response to the elapsing of preprogrammed or programmed intervals. In some examples, the activation of fragile code identifier 102 may be premised on an event within a repository of source code.

Hardware processor 602 may execute instruction 608 to retrieve churn data associated with a source code among a repository of source code. In certain examples, the retrieval of data may be through direct communication with SCM 104 and BTS 108. In other examples, the retrieval of churn data may utilize interface module 106. In some examples, depending on the content of the code churn metric, hardware processor 602 may have sub-instructions to retrieve only from SCM 104. In other examples, depending on the content of the code churn information, hardware processor 602 may have sub-instructions to retrieve only from BTS 108.

Hardware processor 602 may execute instruction 610 to identify instances of churn data that are bug/defect-related churn data. Hardware processor 602 may include sub-instructions to compare the retrieved code churn metric from SCM 104 with the retrieved code churn information from BTS 108 and filter code churn metrics that contain churn data for feature-addition commits. In other examples, hardware processor 602, depending on the content of the code churn metric, may include sub-instruction to identify bug/defect-related churn data instances based on only code churn metric from SCM 104. Similarly, hardware processor 602, depending on the content of the code churn information, may include sub-instruction to identify bug/defect-related churn data instances based on only code churn information from BTS 108.

Hardware processor 602 may execute instruction 612 to identify the number of bug/defect-related churn data instances associated with each source code line. Hardware processor 602 may further execute instruction 614 to generate a data structure that includes at least each source code line and their associated number of bug/defect-related churn data.

Hardware processor 602, may execute instruction 616 to cluster data representing a source code line with data representing consecutive source code lines based on statistical analysis. Hardware processor 602 may include sub-instruction to reorganize the data structure, for example deleting and creating a new line in the data structure to represent clustered source code lines. Hardware processor 602 may include sub-instruction to base the clustering on any statistical methods such as standard deviation or other form of mathematical algorithm. Hardware processor 602 may also include sub-instruction to adjust a threshold value that determines the applicability of clustering source code lines.

Hardware processor 602 may execute instruction 618 to rank the clusters of source code lines. Ranking of clusters may be performed through ordering of the matrix created during instruction 610.

Hardware processor 602 may execute instruction 620 to generate a report identifying the clusters of data representing possible fragile areas of the source code. Generating of report may include a bar graph similar to FIG. 5. Generating of report may also include the matrix created during instruction 610 that is further filtered by a threshold value.

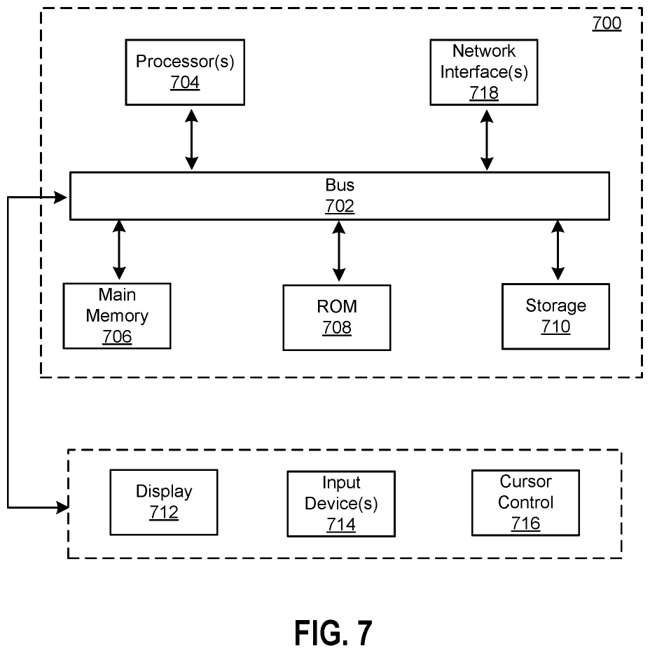

FIG. 7 illustrates a block diagram of an example computer system 700 in accordance with examples of the technology disclosed herein. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random-access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. In some examples, the same direction information and command selections as cursor control may be implemented via receiving touches on a touch screen without a cursor. The computing system 700 may include a user interface module to implement a GUI that may be stored in a mass storage device as executable software codes that are executed by the computing device(s).

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device.

The computer system 700 may implement the techniques described herein using customized hard-wired logic, one or more ASICs or FPGAs, firmware and/or program logic which in combination with the computer system causes or programs computer system 700 to be a special-purpose machine. According to one example, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media.

Non-transitory media is distinct from but may be used in conjunction with transmission media. Transmission media participates in transferring information between non-transitory media.

The computer system 700 also includes a communication interface 718 coupled to bus 702. Network interface 718 provides a two-way data communication coupling to one or more network links that are connected to one or more local networks. Wireless links may also be implemented. In any such implementation, network interface 718 sends and receives electrical, electromagnetic or optical signals that carry digital data streams representing various types of information.

The computer system 700 can send messages and receive data, including program code, through the network(s), network link and communication interface 718. In the Internet example, a server might transmit a requested code for an application program through the Internet, the ISP, the local network and the communication interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example examples. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
identifying instances of bug/defect-related churn data associated with a source code file;
identifying a number of bug/defect-related churn data instances associated with each source code line of the source code file;
clustering data representing a source code line with data representing a consecutive source code line to form a clustered data representing the source code line and the consecutive source code line based on similarity of numbers of bug/defect-related churn data instances associated with the source code line and the consecutive source code line;
ranking the clusters of data; and
generating a report of ranked clusters of data.

2. The method of claim 1, wherein identifying the instances of bug/defect-related churn data associated with the source code file comprises;
retrieving code churn metrics from a source code management system and code churn information from a bug tracking system tracking bugs appearing in the source code file; and
retaining the code churn metrics that are bug/defect-related churn data based on the code churn information from the bug tracking system.

3. The method of claim 1, wherein the similarity of numbers of bug/defect-related churn data instances associated with the source code line and the consecutive source code line is based on a statistical analysis.

4. The method of claim 3, wherein the statistical analysis is a standard deviation calculation using the number of bug/defect-related churn data instances.

5. The method of claim 4, wherein the standard deviation calculation is based on an average of the numbers of bug/defect-related churn data instances associated with each source code line of the source code file.

6. The method of claim 1, wherein the ranking the clusters of data is at least based on the numbers of bug/defect-related churn data instances.

7. The method of claim 6, wherein the ranking the clusters of data is also based on a number of source code lines that forms the clusters of data.

8. A method comprising:
identifying records of bug/defect-related commits associated with a source code file;
identifying a number of bug/defect-related commit records associated with each source code line of the source code file;
clustering data representing a source code line with data representing a consecutive source code line to form a clustered data representing the source code and the consecutive source code line based on similarity of numbers of bug/defect-related commit records associated with the source code line and the consecutive source code line;
ranking the clusters of data; and
generating a report of ranked clusters of data.

9. The method of claim 8, wherein identifying the records of bug/defect-related commits associated with the source code file comprises;
retrieving a log of commits from a source code management system and code churn information from a bug tracking system tracking bugs appearing in the source code file; and
retaining the bug/defect-related commit records based on the code churn information from the bug tracking system.

10. The method of claim 8, wherein the similarity of numbers of bug/defect-related commit records associated with the source code line and the consecutive source code line is based on a statistical analysis.

11. The method of claim 10, wherein the statistical analysis is a standard deviation calculation using the number of bug/defect-related commit records.

12. The method of claim 11, wherein the standard deviation calculation is based on an average of the numbers of bug/defect-related commit records associated with the each source code line of the source code file.

13. The method of claim 8, wherein the ranking the clusters of data is at least based on the numbers of bug/defect-related commit records.

14. The method of claim 13, wherein the ranking the clusters of data is also based on a number of source code lines that forms the clusters.

15. A method comprising:
identifying instances of bug/defect-related churn data associated with a source code file;
identifying a number of bug/defect-related churn data instances associated with each source code line of the source code file, wherein the identifying of bug/defect-related churn data instances associated with each source code line of the source code file comprises generating a data structure that includes entries representing each source code line and the number of bug/defect-related churn data instances for each source code line;
clustering a data entry within the data structure representing a source code line with a data entry representing a consecutive source code line to form a clustered data entry representing the source code line and the consecutive source code line based on similarity of numbers of bug/defect-related churn data instances associated with the source code line and the consecutive source code line;
sorting the clusters of data, wherein the sorting of the clusters of data is at least based on the numbers of bug/defect-related churn data instances; and
generating a report of clusters of data.

16. The method of claim 15, wherein clustering the data entry within the data structure representing the source code line with the data entry representing the consecutive source code line comprises modifying the data entry within the data structure representing the source code line to represent both the source code line and the consecutive source code line and deleting the data entry representing the consecutive source code line.

17. The method of claim 15, wherein identifying the instances of bug/defect-related churn data associated with the source code file comprises;
retrieving code churn metrics from a source code management system and code churn information from a bug tracking system tracking bugs appearing in the source code file; and
retaining the code churn metrics that are bug/defect-related churn data based on the code churn information from the bug tracking system.

18. The method of claim 15, wherein the similarity of numbers of identified bug/defect-related churn data instances associated with the source code line and the consecutive source code line is based on a statistical analysis.

19. The method of claim 18, wherein the statistical analysis is a standard deviation calculation using the number of bug/defect-related churn data instances.

20. The method of claim 15, wherein the report of clusters of data includes the data structure.
